(19) United States
(12) Patent Application Publication
(10) Pub. No.: US 2016/0210333 A1
(43) Pub. Date: Jul. 21, 2016

(54) METHOD AND DEVICE FOR MINING DATA REGULAR EXPRESSION

(71) Applicant: SHENZHEN AUDAQUE DATA TECHNOLOGY LTD, Middle Nanshan District Shenzhen (CN)

(72) Inventors: Mingxing Wang, Shenzhen (CN); Xibei Jia, Shenzhen (CN)

(21) Appl. No.: 14/748,625

(22) PCT Filed: Aug. 8, 2014
(86) PCT No.: PCT/CN2014/083934

§ 371 Date: Jun. 24, 2015

(30) Foreign Application Priority Data
Aug. 12, 2013 (CN) 201310347701.8

(51) Int. Cl. G06F 17/30

(52) U.S. Cl. CPC G06F 17/30539

(57) ABSTRACT

Provided is a method for mining a data regular expression. The method comprises: obtaining data to be stored, and storing the data by using a dictionary tree structure; performing a node upgrade according to a regular expression rule; separately performing branch combination according to the number of subnodes having a same character; identifying an interfering branch, and performing branch deletion; and converting a rule tree to be in a character string format and outputting it. Obtained data is stored in a dictionary tree structure, so that mass data can be mined, data nodes are upgraded, branches are combined, an interfering branch is deleted, and finally, a generated rule tree is converted to be in a character string format for outputting, so as to mine a regular expression of mass data comprising erroneous data, and the rule tree can meet the requirement for mining the erroneous data and can be used to check data and find erroneous data thereof. In addition, further provided is a device for mining a data regular expression.

### TECHNICAL FIELD

The present disclosure relates to data processing field, and particularly to a method and device for mining data regular expression.

### BACKGROUND

Data mining refers to a process extracting unknown but valuable information from a lot of incomplete, ambiguous and erroneous data. Data mining process generally includes data preprocessing, implementation of data mining algorithms and demonstration of mining results. Early data mining process was implemented by utilizing serial computing run on single node. For the data mining system with a single node, the amount of data to be mined and the load level of algorithm thereof depended on the performance of a single execution node. Since the current data mining system are required to process mass data, this way of serial computing run on single node could only support a small amount of data with a lower performance. Later, with the development of data mining technology, there have been some methods which use multiple parallel computing within a workflow in current mining methods so as to solve the problem of low efficiency resulting from the above-mentioned way of serial computing run on single node. In parallel processing, when multiple parallel data process tasks are triggered, an execution node is assigned to each data process task, so that the multiple parallel data process tasks are executed in parallel on their correspondingly assigned nodes. The data process tasks at the execution nodes are allocated to and processed by Map tasks performed in parallel through Map/Reduce mechanism, and the results of the data process tasks corresponding to the Map tasks respectively are merged and processed to obtain corresponding process results of the data process tasks.

A regular expression, employed in applications like text matching, data analysis, data error tolerance, business analysis and more, refers to a mode describing string matching. Regex engine can be divided into two major categories: DFA and NFA. Both engines have a long history (more than twenty years so far), which has derived many variants. Accordingly, POSIX has been introduced to specify the variants produced already or to be produced. As a result, mainstream regex engines have been divided into three kinds: DFA, traditional NFA and POSIX NFA. There have been a lot of methods and techniques about applications of regular expression, but seldom about how to generate a more effective regular expression. For example, although “PRACTICAL REGULAR EXPRESSION MINING AND ITS INFORMATION QUALITY APPLICATIONS” proposed by Sergei Savchenko has presented a regex mining method based on intelligent finite automaton, there existed a significant limitation, such as the requirement of distribution and the size of dataset can only be between 30-50.

Currently, there may not exist a mining method for mining data structure and forming a regular expression from mass data containing erroneous data in the data processing field.

### SUMMARY

For this purpose, the present disclosure is aimed to solve one of the above-mentioned drawbacks.

Therefore, a method and device for mining a data regular expression are provided in the present disclosure. By means of storing acquired data in a dictionary tree structure, performing an upgrade on a data node according to a pre-established regular expression rule form, then performing branch combination according to the number of subnodes of upgraded nodes and the number of subnodes having a same character, identifying an interfering branch and performing branch deletion, and finally converting a rule tree to be in a character string format and outputting it, mass data can be mined. The present disclosure realizes mining a data regular expression of mass data comprising erroneous data, and the rule tree can meet the requirement for mining the erroneous data and can be used to check and find out erroneous data thereof.

As a result, a method for mining data regular expression is provided in one embodiment of the present disclosure, wherein the method comprises:

obtaining data to be stored, and storing the data by using a dictionary tree structure;

performing a node upgrade according to a regular expression rule;

separately performing branch combination according to the number of subnodes of upgraded nodes and the number of subnodes having a same character;

identifying an interfering branch, and performing branch deletion;

converting a rule tree to be in a character string format and outputting it.

In the embodiment, data is stored by using a dictionary tree structure, and the stored data information comprises: a node character, all nodes, character repeat number, the number of data accessed into a node, and the number of data terminated on a node.

Preferably, the node upgrade comprises: pre-establishing a rule form containing character level and upgrade relationship according to a regular expression rule; performing a node upgrade according to the rule form.

Preferably, the branch combination comprises: vertical combination and horizontal combination; the vertical combination is performed only when a node has only one subnode and the character of the subnode is equal to that of the parent node; the horizontal combination is performed when an upgraded parent node contains subnodes having a same character.

Preferably, identifying an interfering branch comprises: presetting a threshold which is determined based on the product of the average access record number of a node and a coefficient; if the access record number of a branch is less than the threshold, the branch is considered as an interfering branch.

Preferably, the step of identifying an interfering branch comprises: if the termination record number of a node is less than the threshold, the node is considered as an interfering node, and the termination record number of the node should be set to 0.

A device for mining data regular expression is provided by another embodiment of the present disclosure, wherein the device comprises:

a data storage unit configured to store obtained data by using a dictionary tree structure;

a node upgrade unit configured to perform a node upgrade according to a regular expression rule;

a branch combination unit configured to separately perform branch combination according to the number of subnodes of upgraded nodes and the number of subnodes having a same character;

a branch deletion unit configured to delete an identified interfering branch;

a rule tree output unit configured to convert a rule tree to be in a character string format and outputting it.

The data storage unit comprises: the data information stored by the data storage unit comprising node character, all nodes, character repeat number, the number of data accessed a node and the number of data terminated a node.

Preferably, the node upgrade unit comprises: the node upgrade unit pre-establishes a rule form containing character level and upgrade relationship, and performs a node upgrade according to the rule form.

Preferably, the branch combination unit comprises: the branch combination unit performs vertical combination only when a node has only one subnode and the character of the subnode is equal to that of the parent node; the branch combination unit performs horizontal combination when an upgraded parent node contains subnodes having a same character. With the method and device for mining a data regular expression provided in the present disclosure, mass data can be mined by means of storing the obtained data in a dictionary tree structure, performing an upgrade on a data node according to a pre-established regular expression rule form, then performing branch combination according to the number of subnodes of upgraded nodes and the number of subnodes having a same character, identifying an interfering branch and performing branch deletion, and finally converting a rule tree to be in a character string format and outputting it. The present disclosure realizes mining a data regular expression of mass data comprising erroneous data, and the rule tree can meet the requirement for mining the erroneous data and can be used to check and find out erroneous data thereof.

It should be understood that, both the foregoing general description and the following detailed description are explanatory and exemplary, intended to provide further explanation of the claims of the present disclosure.

### BRIEF DESCRIPTION OF THE DRAWINGS

FIG. 1 is a flowchart illustrating a method for mining data regular expression implemented by one embodiment of the present disclosure.

FIG. 2 is a specific flowchart illustrating the level of an initial node being optimized according to one embodiment of the present disclosure.

FIG. 3 is a schematic diagram showing the result of combined nodes according to one embodiment of the present disclosure.

### DETAILED DESCRIPTION

The present disclosure will be described in detail by reference to the accompanying drawings and embodiments for more clearly understanding of the objects, technical features and advantages of the present disclosure. It should be understood that specific embodiments described herein are intended for purposes of illustration only and are not intended to limit the scope of the present disclosure.

With the method and device for mining a data regular expression provided in the present disclosure, mass data can be mined by means of storing the obtained data in a dictionary tree structure, performing an upgrade on a data node according to a pre-established regular expression rule form, then performing branch combination according to the number of subnodes of upgraded nodes and the number of subnodes having a same character, identifying an interfering branch and performing branch deletion, and finally converting a rule tree to be in a character string format and outputting it. The present disclosure realizes mining a data regular expression of mass data comprising erroneous data, and the rule tree can meet the requirement for mining the erroneous data and can be used to check and find out erroneous data thereof.

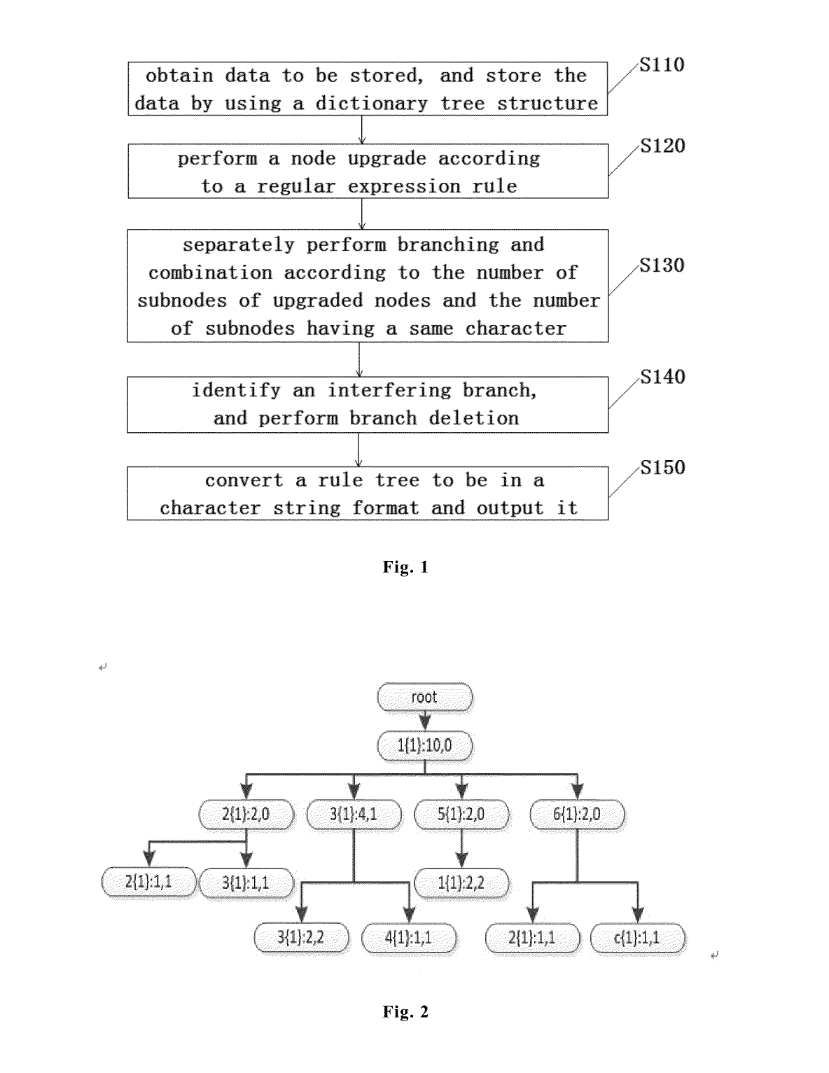

As shown in FIG. 1, it is a flowchart illustrating a method for mining a data regular expression implemented by one embodiment of the present disclosure, which specifically comprises the following detailed steps:

Step S110: obtaining data to be stored, and storing the data by using a dictionary tree structure.

First of all, all the data is scanned one by one, and inserted into a dictionary tree in sequence. For each node in the dictionary tree, besides storing the characters belonging to the node and all subnodes, it also stores character repeat number, the number of data accessed into the node and the number of data terminated on the node. For example, if the following set of data needed to be stored:

151; 122; 133; 13; 16c; 134; 123; 133; 151; 162.

Then, the result of the data stored into the dictionary tree is showed in FIG. 2, where: “root” node is the root node, the meanings of each data at other nodes are: the character before the colon being the character representing the node as well as the number of repeating the character i.e. character repeat number (numeral within the braces), the two numerals after the colon respectively being the number of data accessed into the node (i.e. access record number) and the number of data terminated at the node (termination record number). The repeat number within the braces may also be two numerals which are defined as lower and upper limits of the number of repeating the characters respectively, for example, 2{1,3} represents that the character “2” has been repeated 1-3 times, i.e., the node can match with three cases, “2”, “22” and “222”. When the lower and upper limits are identical, it can be abbreviated to be a numeral, for example, 2{5,5} can be simplified as 2{5}, indicating that it matches with “22222”. The dictionary tree, which is also the rule tree, will be performed by series of operations like character upgrade, branch combination, branch deletion and more, and will be finally scaled down into a small dictionary tree and produce a final regular expression.

Step S120: performing a node upgrade according to a regular expression rule.

After the step S110, the data is stored in the dictionary tree structure. The data nodes store initial characters such as ‘1’, ‘2’, ‘5’, ‘c’, etc., which will lead to many nodes in the dictionary tree having too many subnodes, that is, too many branches. To reduce the number of the branches, in the step, there is a need to extract common features of data of multiple branches and delete interfering branches. Combined with the common format of regular expressions, a number of special character as well as their corresponding levels and corresponding rule forms are developed. The rule forms are shown in the following table 1:

TABLE 1
rule form of regular expression.

| level 0 | level 1 | level 2 | level 3 |
|---|---|---|---|
| digit: 0-9 | \d | | |
| lowercase letter: a-z | \c (can also be | | |
| | expressed as [a-z]) | | |
| uppercase letter: A-Z | \C (can also be | | |
| | expressed as [A-Z]) | | |
| : underline | . . . | | .(dot) |
| character of other | \L | | |
| language: e.g. | | | |
| Chinese character | | | |
| blank character: | \s | \s | |
| spacing, tab | | | |
| character | | | |

At first, in the embodiment of the present disclosure, the levels of initial characters are defined as 0, the root node is a virtual node without needs of output rule and upgrade. The conditions where a node needs to be upgraded comprise the following items:

First, if a parent node is needed to be upgraded, all subnodes are also needed to be upgraded;

Second, if the number of subnodes contained in the parent node is larger than a given value (such as 3), the subnodes are needed to be upgraded;

Third, when meeting the second item, if the number of data accessed into a subnode is larger than a threshold, the subnode will not be upgraded. Here, the threshold can be set to 50% of the number of data of the parent node, that is, a subnode with an absolute majority in data should be remained the same.

Step S130: separately performing branch combination according to the number of subnodes of upgraded nodes and the number of subnodes having a same character.

The branch combination comprises vertical combination and horizontal combination. The vertical combination is performed only when a node has only one subnode and the character of the subnode is equal to that of the parent node; while the horizontal combination is performed when an upgraded parent node contains subnodes having a same character. Details are as follows.

Vertical combination: when a node contains only one subnode, and the character of the subnode is equal to that of the parents node, the subnode can be combined to the parent node, the access record number of the combined node is equal to that of the parent node, the termination record number of the combined node is equal to the sum of the termination record number of the subnode and the termination record number of the parent node. Provided that the upper and lower limits of the character repeat number of the parent node are n1, m1 respectively, the upper and lower limits of the character repeat number of the subnode are n2, m2 respectively, the upper and lower limits of the character repeat number of the combined node are n3, m3 respectively, it is calculated as follows: if the termination record number of the parent node is equal to 0, n3=n1+n2, m3=m1+m2; if the termination record number of the parent node is not equal to 0, n3=n1, m3=m1+m2.

Horizontal combination: when a node is upgraded, since the characters of two upgraded characters of lower level may be identical, for example, the character ‘d’ is upgraded from both characters ‘1’ and ‘2’, which means that the parent node contains subnodes having a same character, it is required to combine the data of nodes having a same character. Provided that the upper and lower limits of the character repeat number of node 1 to be combined are n1, m1 respectively, the upper and lower limits of the character repeat number of node 2 to be combined are n2, m2 respectively, the upper and lower limits of the character repeat number of the combined node are n3, m3 respectively, it is calculated as follows: if the termination record number of the parent node is equal to 0, n3=min(n1,n2); m3=max(m1,m2); the access record number of the combined node is equal to the sum of the access record number of the two nodes to be combined, the termination record number of the combined node is equal to the sum of the termination record number of the two nodes to be combined. If node 1 and node 2 have no subnodes, the combined node also has no subnode; if node 1 and node 2 have only one subnode, provided that node 1 has the subnode, then the subnode of the combined node is equal to the subnode of node 1; otherwise, it is necessary to recursively combine the same subnode of the two nodes with the combining method described in this step.

Since only one subnode “1{1}:10,0” belongs to the root node, and it is no need to upgrade the parent node, the root node remains the same.

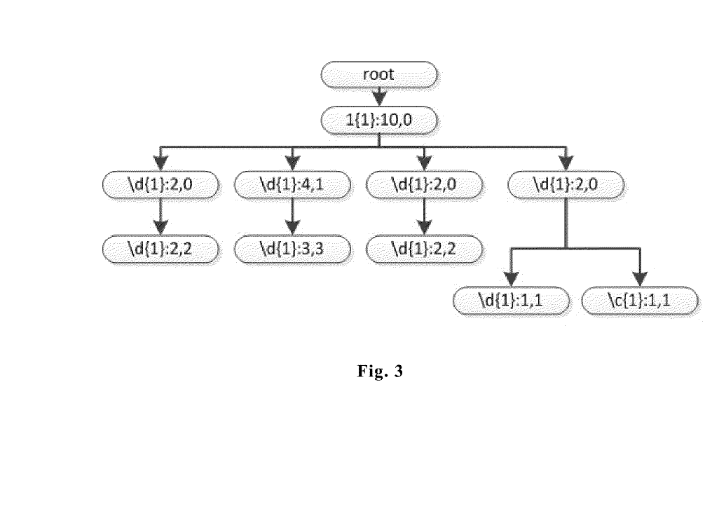

The node “1{1}:10,0” has four subnodes, which exceeds the maximum number of branches of the node (3), and the access record number of each subnode has not reached to an absolute majority, so all subnodes are needed to be upgraded, and simultaneously, all subnodes of the four subnodes are needed to be upgraded and combined, and the result thereof is shown in FIG. 3.

In addition, the node “\d{1}: 10,1” is performed a pruning operation: provided that the total record number of the node is equal to 10, the number of branches is equal to 3 (corresponding to two subnodes, and a terminal node added due to the termination record number of the node being not equal to 0), the threshold coefficient of the access record number of the subnode thereof is equal to 0.5, then the threshold of the access record number of the subnode is: 10/3*0.5=1.67. Since the access record number of the node “\c{1}: 10,1” is less than the threshold, it will be cut out; while the termination record number (1) of the node “\d{1}: 10,1” itself is also less than the threshold, it will be set to 0.

Step S140: identifying an interfering branch, and performing branch deletion.

Since source data is dirty data, there exists an interfering branch after storing the source data to the rule tree, the interfering branch must be identified and removed from the rule tree.

Provided that the access record number of node X is r0, the termination record number is z0, the number of the subnodes thereof is k, and the access record numbers of the k subnodes are ri (i=1, 2, . . . , k) respectively. If z0=0, the branch number of node X is regarded as f=k, otherwise, the branch number is f=k+1; the average access record number of the branch is generally obtained by dividing the number of data accessed into parent node by the number of corresponding subnodes, that is r=r0/f; given a coefficient a (e.g. 0.5), the method for judging a branch to be an interfering branch is: if ri<r*a, the branch i is an interfering branch, the branch and all subnodes thereof are deleted. If z0<r*a, the node X is considered as an interfering node, and the termination record number of the node X is needed to be set to 0.

Step S150: converting the rule tree to be in a character string form and outputting it.

A requisite regular expression is obtained by means of performing series of operations, including upgrading a node, combining branches and deleting an interfering branch, on the rule tree; however, the regular expression is presented in a form of a dictionary tree, so it is needed to be converted to be in a character string form. Provided that there is already a generated rule pr for a node before the current rule tree, the generation method is as follows.

1. if current node has only one subnode, the information of the subnode is directly added in sequence to the output, thus directly outputting 1\d{1,5}.

2. if current node has n subnodes (n>1), a child rule sri is generated by recursively using rule generation on each subnode i, and the final result pr(sr1|sr2| . . . srn) is obtained by combining child rules with adoption of “or” relationship, for example, the data output of the above-mentioned item 1 is: 1(\d{1,5}|c{3}\d{3}).

3. if the termination record number of the current node is not equal to 0, the child rule generated recursively by the subnode thereof is sr, and the final combination way is “pr(sr)”.

Part of the pseudo code of the step is as follows:

```
String generateRule(RuleNode node, String prefix) {
  prefix += genOneNodeRule(node); //adding
  information of current node to the rule
  if(node.getChildNum( )==0) {//if getting to the end
  of the tree, returns generated rule
    return prefix;
  } else if(node.getChildNum( )==1) { //if only exists one
  subnode, generates the rule in
sequence
    RuleNode child = node.getChild(0);
    String childRule = generateRule(child,“”);
    if(node.getEndNum( )>0) { //if the termination
    record number of the node is not
equal to 0, a reference number is needed to be added after the child rule
      return prefix +“( “ +childRule + ”)}
else {
      return prefix+childRule;
    }
  } else {//if there exists a plurality of subnodes,
  child rule is generated recursively for
each subnode, and the child rules are combined
with adoption of “or” relationship
    prefix += “(”;
    boolean bFirst = true;
    foreach RuleNode child (node.getChilds( )) {
      if(bFirst) {
        bFirst = false;
        prefix +=generateRule(child,“”);
      } else {
        prefix += “|”;
        prefix += generateRule(child,“”);
      }
    }
    prefix += “)”;
    if(node.getEndNum( )>0) {//if the termination
record number of the node is not
equal to 0, a reference number is needed to
be added after the sub rule.
```

After another round of operations of upgrading and combining, if no node is needed to be upgraded and combined, the modification of the rule tree is stopped. The result of the rule tree is outputted, thus obtaining a regular expression rule: “1\d{2}”.

In addition, a device for mining data regular expression is provided in another embodiment of the present disclosure. A set of data is stored in a data storage unit by using a dictionary tree structure:

151; 122; 133; 13; 16c; 134; 123; 133; 151; 162.

FIG. 2 shows the result of saving the above data into the dictionary tree by the data storage unit. Besides the character belonged to the stored node and all subnodes of the node, the stored data further comprises the repeat number of the character, the number of data accessed into the node and the number of data terminated on the node.

A node upgrade unit performs a node upgrade according to a regular expression rule. The conditions where a node needs to be upgraded are as follows: if a parent node is needed to be upgraded, all subnodes thereof are also needed to be upgraded; if the number of subnodes contained in a parent node is larger than a given value (such as 3), the subnodes thereof are needed to be upgraded; when meeting the second item, if the number of data accessed a subnode is larger than a threshold, the subnode will not be upgraded. Here, the threshold can be set to 50% of the number of data accessed into the parent node, that is, a subnode with an absolute majority in data should be remained the same.

A branch combination unit comprises two ways, vertical combination and horizontal combination. Vertical combination is performed only when a node has only one subnode and the character of the subnode is equal to that of the parent node; while the horizontal combination is performed when an upgraded parent node contains subnodes having a same character. Since only one subnode “1 {1}:10,0” belongs to the root node, and it is no need to upgrade the parent node, the root node remains the same. The node “1{1}:10,0” has four subnodes, which exceeds the maximum number (3) of branches of the node, and the access record number of each subnode has not reached to an absolute majority, so all subnodes are needed to be upgraded, and simultaneously, all subnodes of the four subnodes are needed to be upgraded and combined, and the result thereof is shown in FIG. 3.

In a branch deletion unit, provided that the access record number of node X is r0, the termination record number is z0, the access record numbers of k subnodes are ri (i=1, 2, . . . , k) respectively. If z0=0, the branch number of node X is regarded as f=k, otherwise, the branch number is f=k+1; the average access record number of the branch is r=r0/f; given a coefficient a (e.g. 0.5), the method for judging a branch to be an interfering branch is: if ri<r*a, the branch i is an interfering branch, and the branch and all subnodes thereof are deleted. If z0<r*a, the node X is considered as an interfering node, and the termination record number of the node X is set to 0.

A rule tree output unit finally outputs the result of the rule tree and obtains a regular expression rule like “1\d{2}”. With the method and device for mining a data regular expression provided in the present disclosure, mass data can be mined by means of storing the obtained data in a dictionary tree structure, performing an upgrade on a data node according to a pre-established regular expression rule form, then performing branch combination according to the number of subnodes of upgraded nodes and the number of subnodes having a same character, identifying an interfering branch and performing branch deletion, and finally converting a rule tree to be in a character string format and outputting it. The present disclosure realizes mining a data regular expression of mass data comprising erroneous data, and the rule tree can meet the requirement for mining the erroneous data and can be used to check and find out erroneous data thereof.

What is described above is a further detailed explanation of the present disclosure in combination with specific embodiments; however, it cannot be considered that the specific embodiments of the present invention are only limited to the explanation. For those of ordinary skill in the art, some simple deductions or replacements can also be made under the premise of the concept of the present invention.

1. A method for mining a data regular expression, wherein the method comprising the following steps of:
obtaining data to be stored, and storing the data by using a dictionary tree structure;
performing a node upgrade according to a regular expression rule;
separately performing branch combination according to the number of subnodes of upgraded nodes and the number of subnodes having a same character;
identifying an interfering branch, and performing branch deletion; and
converting a rule tree to be in a character string format and outputting it.

2. The method according to claim 1, wherein the data information stored by using a dictionary tree structure comprises: node character, all nodes, character repeat number, the number of data accessed into a node, and the number of data terminated on a node.

3. The method according to claim 1, wherein the node upgrade comprises:
pre-establishing a rule form containing character level and upgrade relationship according to a regular expression rule;
performing a node upgrade according to the rule form.

4. The method according to claim 1, wherein the branch combination comprises:
vertical combination and horizontal combination;
the vertical combination is performed only when a node has only one subnode and the character of the subnode is equal to that of the parent node;
the horizontal combination is performed when an upgraded parent node contains subnodes having a same character.

5. The method according to claim 1, wherein identifying an interfering branch comprises:
presetting a threshold which is determined based on the product of the average access number of a node and a coefficient;
if the access record number of a branch is less than the threshold, the branch is considered as an interfering branch.

6. The method according to claim 1, wherein identifying an interfering branch further comprises:
if the termination record number of a node is less than the threshold, the node is considered as an interfering node, and the termination record number of the node should be set to 0.

7. A device for mining data regular expression, wherein the device comprising:
a data storage unit configured to store obtained data by using a dictionary tree structure;
a node upgrade unit configured to perform a node upgrade according to a regular expression rule;
a branch combination unit configured to separately perform branch combination according to the number of subnodes of upgraded nodes and the number of subnodes having a same character;
a branch deletion unit configured to delete an identified interfering branch;
a rule tree output unit configured to convert a rule tree to be in a character string format and outputting it.

8. The device according to claim 7, wherein the data storage unit comprises:
the data information stored by the data storage unit comprising node character, all nodes, the character repeat number, the number of data accessed into a node and the number of data terminated on a node.

9. The device according to claim 7, wherein the node upgrade unit comprises:
the node upgrade unit pre-establishing a rule form containing character level and upgrade relationship, and performing a node upgrade according to the rule form.

10. The device according to claim 7, wherein the branch combination unit comprises:
the branch combination unit performing vertical combination only when a node has only one subnode and the character of the subnode being equal to that of the parent node;
the branch combination unit performing horizontal combination when an upgraded parent node containing subnodes having a same character.

11. The method according to claim 2, wherein the node upgrade comprises:
pre-establishing a rule form containing character level and upgrade relationship according to a regular expression rule;
performing a node upgrade according to the rule form.

12. The method according to claim 5, wherein identifying an interfering branch further comprises:
if the termination record number of a node is less than the threshold, the node is considered as an interfering node, and the termination record number of the node should be set to 0.
